(19) United States
(12) Patent Application Publication
(10) Pub. No.: US 2006/0040650 A1
(43) Pub. Date: Feb. 23, 2006

(54) Service logic program instance

(76) Inventors: Paul D. Schepers, Frisco, TX (US); Alan L. Gerhardt, Pittsburg, TX (US); Warner Lee Hines, Southlake, TX (US); Robert L. Reeves, Plano, TX (US); Mark S. Evans, Plano, TX (US); Raymond M. Parker, Carrollton, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/924,149

(22) Filed: Aug. 23, 2004

(51) Int. Cl. H04Q 7/00

(52) U.S. Cl. 455/419

(57) ABSTRACT

Networks, methods, and devices are provided for handling service logic program (SLP) instances. One method embodiment includes managing SLP instances in a multiple service logic execution environment (multi-SLEE). The method includes, for each SLEE in the multi-SLEE, saving SLEE instance information to a memory in association with creating an SLP instance to invoke a specialized resource function (SRF). The method further includes, upon a SLEE receiving a message from a SRF dialog, performing a look up of SLEE instance information using a dispatcher on the SLEE.

### INTRODUCTION

In an intelligent network (IN) services are separated from switching equipment and organized in a system such that network providers do not have to perform major modifications on multiple switches when a new service is introduced. IN development involves providing separate service data to databases outside of switching equipment nodes. Service programs (service logic) are similarly separated outside of the switching equipment nodes. Further, protocols are defined to permit interaction between switching systems and the intelligent nodes which contain the separated service logic and data.

A switch in a publicly switched telephone network (PSTN) connects a call signal, or other media data traffic, on one media channel to another available media channel in order to continue routing the signal to the intended destination. A switch can perform its function based on Signaling System 7 (SS7) control signals. The SS7 protocol sets up and tears down the call, handles all the routing decisions and supports all modem telephony services, e.g., 800 numbers, call forwarding, caller ID, local number portability (LNP), etc.

Advanced INs provide enhanced voice, video, and data services and dynamic routing capabilities by using two different networks. That is, the actual voice call is transmitted over a circuit-switched network, but the signaling, e.g., control signal transmission, is done on a separate SS7 packet-switched network. For example, an originating switch in a local exchange carrier (LEC) network may determine when processing for enhanced services is required for a telephone call. When processing for enhanced services is requested, the originating switch opens a dialogue with another media platform, e.g., a service control gateway as the same are known and understood in the art, and exchanges higher-level protocol messages embedded within lower-level SS7 protocol messages with the service control gateway.

Signaling System 7 (“SS7”) is a well known dialogue-based communications protocol used for signaling and which may be used for communications with computing platforms such as telecommunications platforms, e.g., mobile switching center (MSC) gateways, service control gateways, or other service capability servers (SCSs), etc., as the same are known and understood by one of ordinary skill in the art. The data exchanged using the SS7 protocol between an originating switch and, for example, a service control gateway is commonly formatted into intelligent network application protocol (“INAP”) messages. At the end of the exchange of INAP messages, e.g., that comprises the dialogue between the originating switch and the service control gateway, the service control gateway directs the originating switch to connect the telephone call to a final destination in order to facilitate the transfer of a media stream, e.g., voice, data, and/or video, etc, over a media channel, e.g., DS0, T1, DS3, SONET, etc., as the same are known and understood by one of ordinary skill in the art. Messages can be arranged in an octet format. Each octet represents a byte, or 8 bits of data, presented as a pair of hexadecimal values.

FIG. 1 illustrates one example of some of the physical components (also referred to as physical entities (PEs)) in a telecommunications network. In this example a mobile network, or wireless telecommunications network 100, is illustrated. Wireless telecommunications networks such as shown in FIG. 1 can be operated by an industry wireless provider or operator, e.g., Cingular, Vodafone, Verizon, Nextel, Sprint, and T-Mobile. Such wireless networks can provide cellular/PCS (personal communication service) services like call origination and call delivery, streaming data, text messaging, etc., for an appropriately enabled roaming mobile device or handset 102. These wireless networks 100 include one or more mobile switching centers (MSCs) 104 and 124 which are connected to a plurality of base stations (BS) 106 and 126 that are dispersed throughout the geographic area serviced by the system. Each MSC 104 and 124 is responsible for, among other things, establishing and maintaining calls between mobile devices and/or between a mobile device and a wireline terminal which is connected to the wireless network from a local and/or long-distance networks, e.g., the regional Bells, Sprint, MCI, etc, in the PSTN 120.

An MSC 104/124 is a telephone switch specialized for wireless and mobility support. As mentioned above an MSC 104/124 performs various functions, including mobility management, call handoffs, call admission, call control, resource allocation, and so forth. A call and/or other data can be relayed from the MSC 104/124 to base stations 110/126 and via a wireless communication interface 105 (e.g., via an ANSI, GSM, standards interface, etc., as the same are known and understood by one of ordinary skill in the art) to the mobile device 102.

A base station 110/126 may transmit subscriber identity information to a serving MSC 104, via communication line 112, where it can be stored in a database associated with the MSC. Messages such as a Mobile Application Part (MAP) based signal, e.g., a registration notification signal (IS-41 message) or location update signal (GSM message), can further be transmitted from the serving MSC 104 to a home location register (HLR) 116 via a signaling link such as a signal transfer point (STP) 114. An STP is an intelligent node in the SS7 telephone network that routes messages between exchanges and between exchanges and databases that hold subscriber and routing information. In the embodiment of FIG. 1, the STP 114 routes the MAP based signal to a gateway MSC 118. As shown in FIG. 1, the gateway MSC 118 can serve as a network switch for connecting to the public switched telephone network (PSTN) 120.

In voice networks, voice switches known as service switching points (SSPs) query service control point (SCP) databases using packet switches known as signal transfer points (STPs). As shown in FIG. 1, a mobile device 102 and the PSTN 120 can be connected to a number of different gateways, e.g., 130-1, 130-2, . . . , 130-N, (including service control gateways (SCGs), service capability servers (SCSs), etc., as the same are known in the art) across multiple different network types, e.g., ANSI, GSM, etc. FIG. 1 illustrates the PSTN 120 connected to the Internet 132 via gateway 130-2. The Internet 132 can, in turn, connect using TCP/IP to various other gateways, e.g. gateway 130-N.

As one of ordinary will appreciate upon reading this disclosure the multiple physical components (also sometimes referred to as physical entities (PEs)), which are described above and elsewhere herein, can include both hardware and software resources. Among the hardware resources, a component can include logic in the form of one or more processors, field programmable gates arrays (FPGAs), firmware, etc., as well as memory. Memory can store software (e.g., computer readable and executable instructions and other programs) related to a variety of functions and telecommunication service applications executable on and by the components described herein. A processor can operate on computer executable instructions as part of the control logic for controlling operations of a component. Memory can include non-volatile and volatile memory such as Flash memory, read only memory (ROM), random access memory (RAM), and optical memory, among others.

As mentioned above, signal transfer points (STPs) are associated with service switching points (SSPs) and service control point (SCPs). STPs are high-capacity, high-reliability (as those terms will be recognized by one of ordinary skill in the art) packet switches, within the SS7 network, that transport signaling messages, using large routing databases, between the IN nodes, e.g., the service switching points (SSPs) and service control point (SCPs). These IN nodes include access to hardware and software resources such as the processor and memory capabilities described above. A SCP is a physical component node in a SS7 telephone network that provides an interface to databases, which may reside within the SCP node or in other nodes on a network. As noted, the SCP may also be combined with the STP to route messages. The SSP is a physical component node that sends SS7 messages to SCPs to retrieve subscriber and routing information as well as other information from various databases which support such features as 800 and 900 numbers, calling card validation, collect and third-party billing calls.

The software resources, e.g., computer executable instructions, within a network, can be broken down into particular functions (also referred to as functional entities (FEs)), associated with SSPs and SCPs, as illustrated in FIG. 2. FIG. 2 provides an embodiment of a FE diagram which is useful to illustrate classes of functions as the same are understood in object oriented programming, e.g., the software resources of intelligent nodes. As mentioned above, for SSPs and SCPs, e.g., intelligent nodes to work, common channel signaling, or out-of-band signaling, is required as opposed to the traditional inband signaling. Relying on out-of-band signaling, e.g., SS7 protocols, provides the mechanism to place service logic and service data into dedicated network elements that can remotely handle call control and connection. SS7 also enables intelligent applications to communicate with other applications and to access databases located in various parts of the network.

The physical component of an SSP 201 provides stored program control switches, e.g., computer executable instructions, that interface to the SS7 signaling network 200. The SS7 network 200 includes STPs (not shown) as the same have been described above. As shown in the embodiment of FIG. 2, the SSP 201 includes software executable to perform a call control function (CCF) 202, and software executable to perform a service switching function (SSF) 203. As one of ordinary will appreciate, the physical component of an SSP 201 can associate with the software functional components (e.g., FEs) of a CCF and SSF in a distributed manner, e.g., the software is distributed across multiple network computers such as in a local area network (LAN), a wide area network (WAN), and/or the Internet. As used herein a CCF includes executable instructions to control call processing and provides network connection services. An SSF includes executable instructions to support IN triggering during call processing and to access to IN functionality. The SSF recognizes IN service calls and routes the appropriate queries to a service control function (SCF) (discussed below) that resides in a SCP via the SS7 network through STPs.

As shown in the embodiment of FIG. 2, the SSP 201 can also include software executable to perform a specialized resource function (SRF) 204 and software executable to perform a call control agent function (CCAF) 205. The SRF 204 includes executable instructions to support interaction between call processing software on the switch, e.g. SSP 201, and a SCF (discussed below). The CCAF 205 includes executable instructions to support specialized network resources generally associated with caller interaction and to provide user access to the network.

The physical component of an SCP 206 provides stored program commands, e.g., computer executable instructions, that are interfaced to the STP nodes (not shown) within the SS7 signaling network 200. SCP commands are used by the SSP 201 to process calls. The SCP 206 is a fault-tolerant, high-capacity (as those terms will be recognized by one of ordinary skill in the art) transaction-processing entity that provides call-handling information in response to SSP 201 queries. As shown in the embodiment of FIG. 2, the SCP 206 includes software executable to perform a SCF 208 and can include software executable to perform a service data function (SDF) 210. The SCF 208 includes instructions to execute IN service logic and influence call processing on the switch, e.g., SSP 201, via its interface to the SSF 204 through the SS7 network 200.

The physical component of a service management point (SMP) 212 provides operation, administration, and maintenance functions for the IN. As one of ordinary will appreciate, the physical component of an SMP 212 includes the functional components (FEs) of a service management function (SMF) 214 and a service management access function (SMAF) 216. The SMF 214 includes executable instructions to allow deployment and provision of IN services and to allow the support of ongoing operation. The SMAF includes executable instructions to provide an interface between service managers and the SMF 214.

The physical component of an intelligent peripheral (IP) 218 generally includes software to perform a SRF 220, as the same has been described above and will be described further below. The IP 218 can be connected to an SSP 201 over a high speed bus, e.g., a common object request broker architecture (CORBA) bus. The IP 218 uses the SRF 220 to provide enhanced services or functions, e.g., web enabled application services, such as a Parlay application, as the same will be known and understood by one of ordinary skill in the art. The IP 218 can also employ a SRF 220 to manage resources such as announcements, speech recognition, digit collection, protocol conversions, etc. In other words, a SRF includes executable instructions to support specialized network resources generally associated with caller interaction with the IN. The SRF 220 starts a dialog, e.g., message exchange, under the control of an SCF 208 in the SCP 206. As shown in FIG. 2, the SRF 220 is coupled to the SCP 206 through the SS7 network 200 and possibly relayed by an SSP 201.

The physical component of a service creation environment point (SCEP) 222 can include a service creation environment function (SCEF) 224. The SCEF includes executable instructions to allow services provided in the IN to be defined, developed, tested, and input to the SMF 214. The physical component of a service data point (SDP) 226 can include a service data function (SDF) 228. The SDF 228 includes instructions to manage customer and network data for real-time access by the SCF 208 in the execution of an IN service.

The IN architecture is fundamentally based on SS7 and its protocol architecture. In a first level a signaling transport capability, known as the message transfer part (MTP), handles the corresponding open systems interconnection (OSI) physical, data-link, and network layers, as the same are known within the OSI model. A next level, referred to as the signaling connection control part (SCCP), augments the MTP by providing both connectionless and connection-oriented message transport, as well as enabling addressing capabilities for message routing. A next level, referred to as the transaction capabilities application part (TCAP) provides procedures for real-time transaction control. The TCAP is used to send database queries to a SCP 206. It is also used to send non-circuit related messages between switches, e.g., SSPs 201. TCAP keeps track of multiple queries that are part of the same session, e.g., message exchange associated with a call or service request. A final layer, referred to as the IN application protocol (INAP), defines the operations required between IN network elements, such as SSPs 201 and SCPs 206. INAP protocols are used to initiate non-circuit related functions (e.g., not dealing with connect/disconnect) throughout the network 200. INAP protocols use TCAP to access remote devices.

In summary, FIG. 2 illustrates that each functional entity is mapped to a particular physical entity with a given network. Information flows between the functional entities, described above, are implemented in the physical entities, also described above, through the appropriate INAP. Thousands and even tens of thousands of sessions, e.g., message exchanges, associated with a call or service request may be occurring concurrently in a given network.

FIG. 3 illustrates an SCF model which can be implemented within an SCP on a network as the same have been described above. As shown in FIG. 3, the SCF model includes a service logic program (SLP) library 301 coupled to a service logic execution environment (SLEE) 302. One of ordinary skill the art will appreciate the terms SLP, SLP library, and SLEE. More discussion is not provided so as not to obscure aspects of the invention discussed below. As shown in FIG. 3, the SLEE can couple to an SMF 303, a SSF 304, a SRF 305, and a SDF 306 (as the same have been described above) via a functional entity access manager 307, as the same will be known and understood by one of ordinary skill in the art.

The general operation of a SLEE 302 includes processor and memory resources as well as computer executable instructions (e.g., software, firmware, etc.), storable in memory and executable by a processor therein. As shown in the embodiment of FIG. 3, these resources are embodied in the form of an SLP manager 308, which is coupled to the SLP library 301 and the functional entity access manager 307. As shown in the example of FIG. 3, a service logic execution manager 310 is illustrated in association with the creation of a number of SLP program instances, 314-1, . . . , 314-N, (described in more detail below) via interaction with a service logic selection/interaction manager 312 and a resource manager 316, as the same will be appreciated by one of ordinary skill in the art. As illustrated in FIG. 3, the service logic execution manager 310 can further interact with a functional routine library 320 (including functional routines) which can further connect with the functional entity access manager 307 via a functional routine manager 322. Functions and routines as sets of computer executable instructions are well known to those of ordinary skill in the art. As illustrated in the example of FIG. 3, the service logic execution manager 310 can interact with an SCF data access manager 324 which can access a service data object directory 326 and IN network-wide resource data 328 as the same will be known and appreciated by one of ordinary skill in the art.

In reference to FIG. 3, the reader will appreciate that within the SLEE environment there is a finite amount of memory that can be used for SLP instances and that each SLP instance has a certain static memory footprint. An SLP instance can handle a session, e.g., message exchange, with a SRF as the same have been described herein. When a new SLP instance is created for every SRF dialog a significant amount of memory resources are utilized. As network systems have grown in resources, e.g., the prevalence of multiple processor (CPU) computing devices within the network, the occurrence of multiple SLEE environments has increased, further increasing the amount of memory resources consumed.

### BRIEF DESCRIPTION OF THE DRAWINGS

FIG. 1 is a block diagram illustrating an example of a communications network.

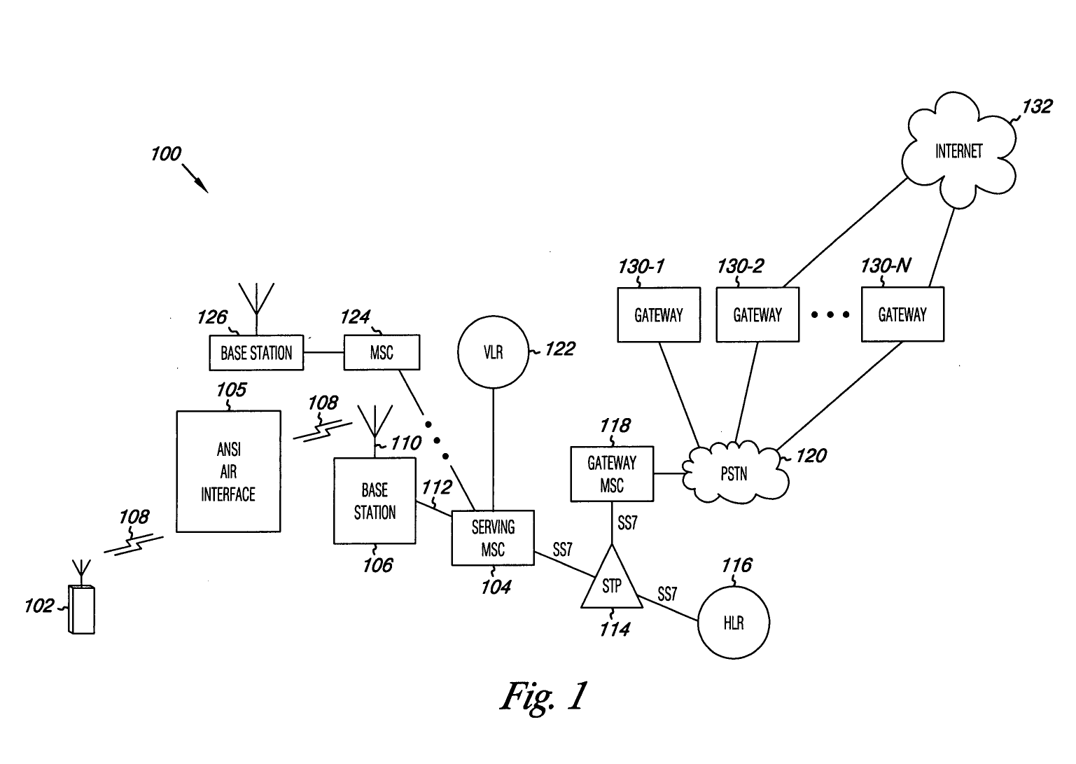

FIG. 2 illustrates block diagram example of mapping functional entities and physical elements within a network such as illustrated in FIG. 1.

FIG. 3 is an example illustration of a service control function model, having hardware and software, as can exist within a service control point in the above described networks.

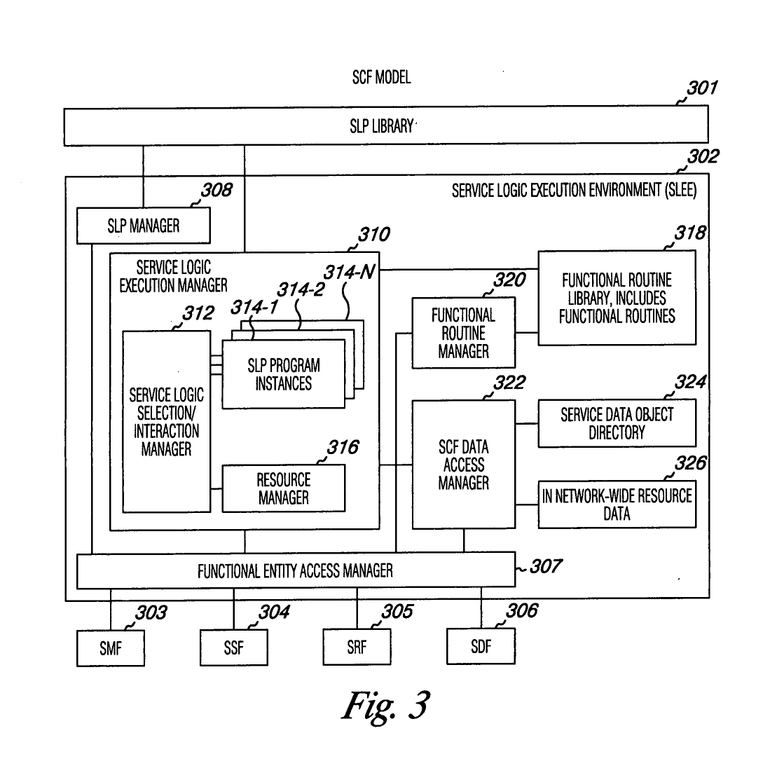

FIG. 4 illustrate a multiple service logic execution environment (multi-SLEE) as can exist within a service control point in the above described networks.

FIG. 5 is a block diagram illustrating an operational embodiment of a SLEE having hardware and software such that a SLP instance invoking a SRF can save SLEE instance information in a multi-SLEE environment as shown in FIG. 4.

FIG. 6 illustrates an embodiment of a network interfacing a service control multi-SLEE environment with web service applications.

### DETAILED DESCRIPTION

Embodiments of the present invention provide for efficient management of SLP instances within a multi-SLEE environment. According to various embodiments, in association with a multi-SLEE service control platform, e.g., service control gateway or service capability server, SRF interaction overhead is reduced by utilizing existing SLP instances when possible. When a SLP instance is created to invoke a SRF and start a SRF dialog, program instructions execute in conjunction with the invoking SLP to save SLEE instance information (e.g., the information on the SLEE containing the invoking SLP instance and information identifying the invoking SLP) keyed by a correlation ID. Program embodiments execute instructions using a SLEE dispatcher to look up the SLEE instance of each invoking SLP based on correlation ID information received in a return message to the dispatcher from an invoked SRF. When the correlation ID in the received message matches the correlation ID of the SLEE instance, program embodiments execute instructions to forward the SRF dialog to the invoking SLP instance. In a multi-SLEE environment, when the SLEE instance is matched in a look up (i.e., the same), an instance of the SLP can be conserved. Thus, the number of SLP instances employed to handle a session, e.g., message exchange/dialog, is reduced. Conservation of SLP instances conserves memory and thus allows more instances to handle more sessions on identical hardware.

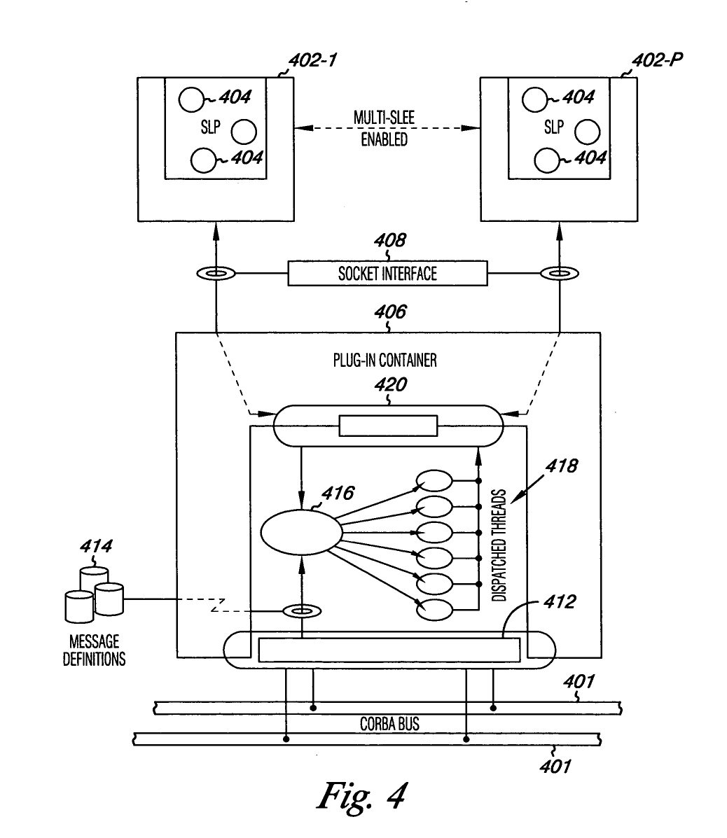

FIG. 4 illustrates an example of a multiple service logic execution environment (multi-SLEE) for a service control function (SCF) associated with a service control point (SCP) in the above described networks. An SCP provides a SLEE in which instances of one or more service logic programs (SLPs) can execute. The SLEE and SLPs together provide service control functionality for providing services to the SSP.

A network computing device such as a server, having processor logic and memory, includes an operating system layer and an application layer to enable the device to perform various functions or roles. The operating system layer includes a “kernel”, e.g., master control program, that runs the computing device. The kernel provides task management, device management, and data management, among others. In other words, the kernel sets the standards for application programs that run on the computing device or for interfacing to application program which reside elsewhere in the network. The application layer includes programs applications, e.g., executable instructions, which are located above the operating system layer and accessible by a user. Before a computing device may accomplish a desired task, it receives an appropriate set of instructions. Executed by a device's processor(s), these instructions direct the operation of the device. These instructions can be stored in a memory of the computer. Instructions can invoke other instructions. As used herein, “user level” implies a layer of code which is more easily accessible, e.g., includes open-source code, than the layer of code which is in the operating system layer or “kernel” space. User space applications, or programs, reside above the kernel space of a network computing device and can reside elsewhere with the network.

FIG. 4 illustrates a high speed bus 401, e.g., a common object request broker architecture (CORBA) bus as the same is known and understood by one of ordinary skill in the art, which can provide a connection between other user space network applications (not shown), e.g., web-enabled applications such as a Parlay application, and a multi-SLEE environment, 402-1, . . . , 402-P. The multi-SLEE environment, 402-1, . . . , 402-P, provides the service control functionality (SCF) in association with a service control point (SCP) in the network, as the same has been described above. The designator “P” is used to indicate that embodiments are not limited to a particular number of SLEEs in a multi-SLEE environment. The given number of SLEEs in a multi-SLEE environment will be associated with the amount of processing resources available, e.g., multiple processors (CPUs) in a given computing device on the network. Each SLEE is generally assigned to a particular processor, however, multiple SLEEs can be assigned to one processor and the associated memory allocated to that particular processor.

As illustrated in the example of FIG. 4, each SLEE can have multiple instances of SLPs 404 at a particular point in time. As will be appreciated by one of ordinary skill in the art, a process is a running program with input, output, and a state. Each process has one or more threads. A thread is an executable set of instructions being executed by a single processor. An instance, as used herein, refers to a “user level” thread. A thread is sometimes referred to as a lightweight process. A process contains attributes shared by all executing threads in the process, such as an address space, file descriptors, variables of an executing instance of a program, etc. Processes and threads are well known in the art and are described, for example, in Modern Operating Systems, Andrew S. Tannenbaum, (1992). As used herein, an SLP instance can be associated with a user level thread for a user level program or application.

In the example illustration of FIG. 4, the multiple SLEEs, 402-1, . . . , 402-P, can be interfaced to the bus 401 via a plug-in container 406, e.g., as part of a service control gateway (SCG) or service capability server (SCS), as the same will be appreciated by one of ordinary skill in the art. As illustrated in the example the multiple SLEEs, 402-1, . . . , 402-P, can connect to the plug-in container 406 via a socket interface 408 as the same are known and understood by one of ordinary skill in the art.

As messages are exchanged between the plug-in container 406 and the bus 401 they are handled by an external component interface 412 provided to the plug-in container 406. Program instructions can execute in connection with the external component interface 412 to retrieve message definitions from a message database 414 and provide the same to a thread manager 416. A thread manager includes logic control for the execution of various processes and their associated threads.

The example illustration of FIG. 4 shows a number of dispatched threads 418 from the thread manager 416. The dispatched threads 418 are exchanged with the multiple SLEEs, 402-1, . . . , 402-P, through a plug-in communication application program interface (API) 420 and via a socket interface 408 as the same will be known and understood by one of ordinary skill in the art.

The various SLPs 404 within the multiple SLEEs, 402-1, . . . , 402-P, can contain the connection information to various user applications, or programs, e.g., web-enabled applications such as a Parlay application, which are located elsewhere in a network and coupled to the multiple SLEEs, 402-1, . . . , 402-P, via the bus 401 and the plug-in container 406. The application logic itself is not contained in the multiple SLEEs, 402-1, . . . , 402-P, but rather the multiple SLEEs, 402-1, . . . , 402-P, provide the connection information as part of the SCF to access user applications, or programs located elsewhere in the network.

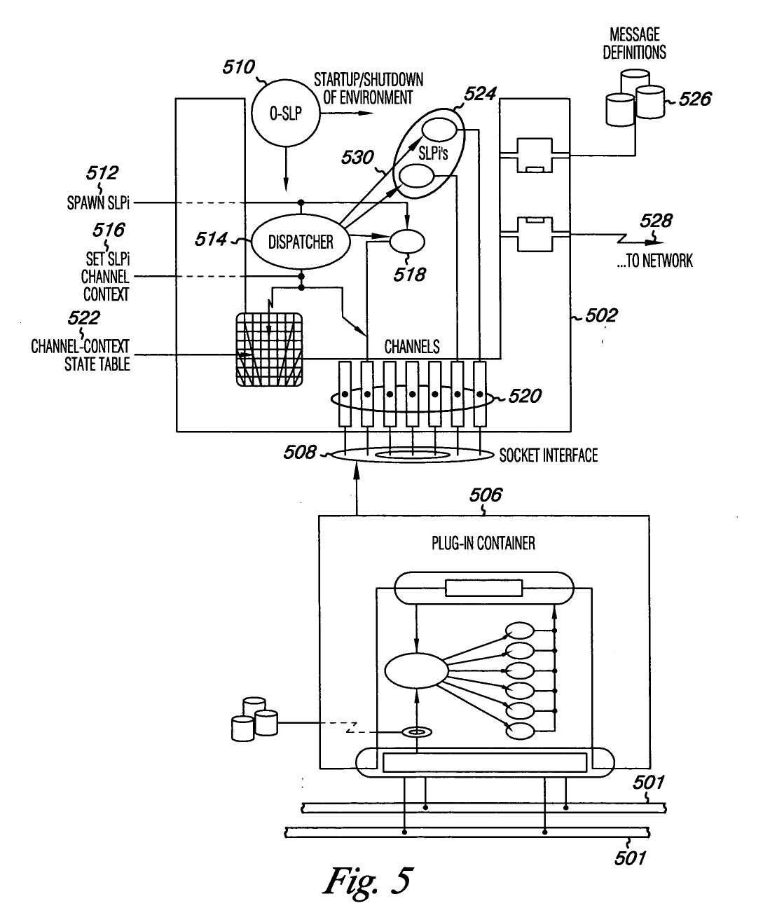

FIG. 5 is a block diagram illustrating an operational embodiment of a SLEE 502, within a multi-SLEE environment such as that illustrated in FIG. 4, having program embodiments to save off SLEE instance information when a SLP instance is created to invoke a SRF. The program embodiments are storable in memory and executable by a processor associated with a particular SLEE within a multi-SLEE environment. As shown in the embodiment of FIG. 5, the SLEE 502 can be connected to a high speed bus 501 (e.g., for access to other user applications, or programs) in a communications network through a plug-in container 506 via a socket interface 508 as the same have been described above in connection with FIG. 4.

As shown in the embodiment of FIG. 5 an operational service logic program (O-SLP) 510 can execute instructions to startup and shutdown the SLEE 502 environment as the same will be known and understood by one of ordinary skill in the art. The SLEE 502 can receive instructions to spawn, e.g., create other SLP instances (SLPi) as illustrated at 512. Upon startup, the O-SLP will create a dispatcher 514 which itself is an SLP. Hence, SLPs can invoke, or activate, other SLPs as the same will be appreciated by one of ordinary skill in the art. When an SLP instance begins 512 it communicates with a dispatcher 514. The dispatcher 514 provides control logic, e.g., as program instructions stored in SLEE memory and executable by the processor to which the SLEE is assigned, in order to set SLPi channel context as shown at 516. In other words, the newly created SLP instances (SLPis), e.g., 518 will be assigned a channel (e.g., a DS0 as the same will be appreciated in telecommunications parlance), shown generally as 520, to communicate with the socket interface 508. As illustrated in the embodiment of FIG. 5, the dispatcher 514 can additionally communicate with a channel context state table (shown at 522), as the same will be appreciated by one of ordinary skill in the art, to track which SLP instances, for example, SLPis 524 and 518, have been assigned to which particular channels 520. The more SLP instances are created by the SLEE, the more memory associated with the SLEE is consumed. As mentioned above, the SLP instances provide the connection information to handle sessions, e.g., exchange messages for calls and services to other parts of the network.

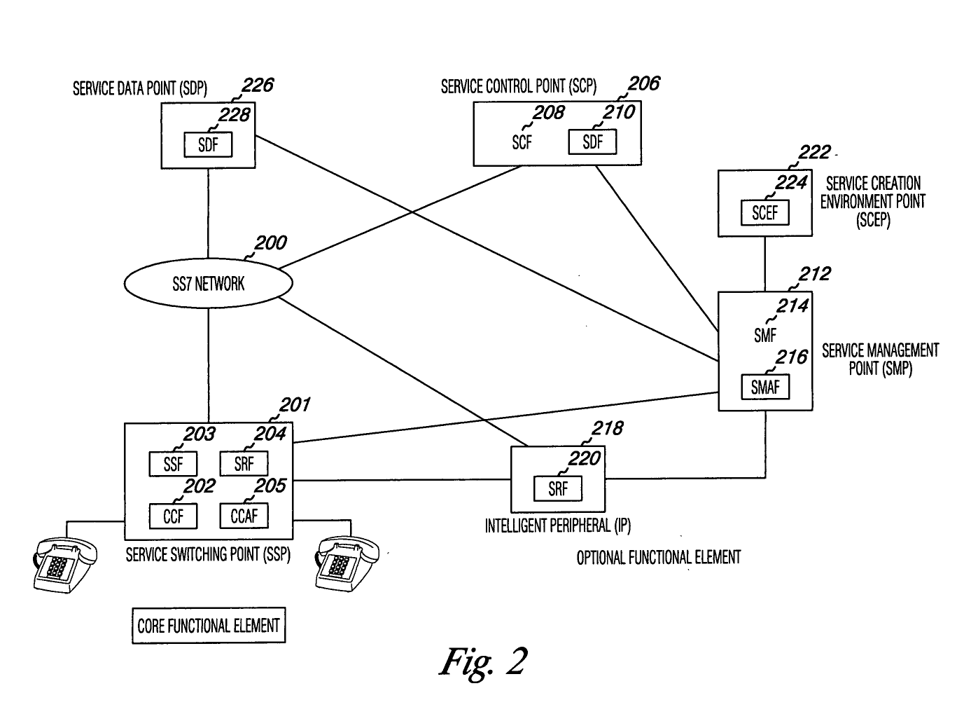

As shown in FIG. 5, the SLEE 502 can similarly have connections to other databases 526, e.g., for message definitions or otherwise, such as a service data point (SDP) having a service data function (SDF), as the same have been described above in connection with FIG. 2. A given SLEE 502 can also include other connections to the network 528, e.g., for connections to service switching points (SSPs) having service switching functions (SSFs), specialized resource functions (SRFs), call control functions (CCFs), etc., as the same have been described above in connection with FIG. 2. The other network entities (such as those shown in FIG. 2) can include intelligent peripherals (IPs) including SRFs to provide enhanced services or functions, e.g., to access web-enabled service applications such as a Parlay application, under the control of an SCF implemented as a multi-SLEE in association with an SCP through an SS7 network and possibly relayed by an SSP. As mentioned above, a SRF includes executable instructions to support specialized network resources generally associated with caller interaction with the IN and can also manage resources such as announcements, speech recognition, digit collection, protocol conversions, etc.

An SLP instance can be created to invoke a specialized resource function (SRF) as the same has been described above. Generally, when a SLP instance, e.g., 518, 524, establishes connection information, it exchanges a transaction ID with the device or network element with which the connection is being formed. These transaction IDs can be included within INAP and/or TCAP protocols, etc., as the same will be known and understood by one of ordinary skill in the art. However, in the case of an SLP instance created to invoke a SRF a different issue arises. By its very nature the SRF is intended to start a new dialog altogether with another network resource. As such, the SRF starts a new message transaction with its own associated transaction ID with that other network resource. Hence, when SRF messages are returned to the SLEE, they do not contain the same transaction ID as the invoking SLP instance. Without more of an identifier in a multi-SLEE environment, the receiving SLEE will simply create a new SLP instance to handle the SRF and thus expending memory resources.

Program embodiments of the present invention provide a solution to this issue by executing to save SLEE instance information to a memory associated with the SLEE when a service logic program (SLP) instance is created to invoke a specialized resource function (SRF). Further program embodiments execute to use a dispatcher to perform a look up of the SLEE information in memory when a message is returned from a SRF. The SLEE instance information includes a correlation identifier (ID) representative of a particular SLEE (e.g., particular SLEE within a multi-SLEE) and representative of the particular SLP instance in that SLEE that invoked the SRF. Program embodiments execute instructions such that if a correlation ID received in a return SRF message matches the correlation ID of a SLEE instance found by the dispatcher the SRF dialog can be forwarded to the invoking SLP instance. Thus, in a multi-SLEE environment, rather than having to create a new SLP instance each time a new SRF dialog is received, when a SLEE instance match is found, a SLP instance can be conserved.

As one of ordinary skill in the art will understand upon reading this disclosure, embodiments of the invention can be performed by software and/or firmware, application modules, e.g., computer executable instructions, operable on the systems and devices shown herein or otherwise. The invention, however, is not limited to any particular operating system environment or to software and/or firmware written in a particular programming language. Software, firmware, and application modules, suitable for carrying out embodiments of the present invention, can be resident in one or more devices or locations or in several locations in a distributed network. And, as mentioned above, a given SLEE 502 will have processor and memory resources assigned to it as the same are known and understood by one of ordinary skill in the art.

To achieve the above described solution, various program embodiments execute instructions to construct a correlation ID as a variable length bit string implemented in one or more octets. As mentioned above, an octet represents a byte, or 8 bits of data, presented as a pair of hexadecimal values. Each hexadecimal value can represent a numerical value. The part of the variable length bit string representative of a particular SLEE can be composed of a numerical identifier value assigned to a particular SLEE when the SLEE was created by the O-SLP in the multi-SLEE environment. This numerical identifier value can be stored in memory associated with the SLEE in a look up table, as the same are known, and can be accessed by executing program instructions. Further, the part of the variable length bit string representative of the particular SLP instance in that SLEE that invoked the SRF can be composed of a numerical identifier value assigned to each SLP instance created in the SLEE to invoke a SRF. As each new SLP instance is created in the SLEE to invoke a SRF, the program instructions can execute to combine these two values as a unique correlation ID and save the same to memory associated with the particular SLEE.

According to various embodiments, program embodiments additionally execute instructions such that when a SLP instance is created to invoke a SRF, the correlation ID, as described above, is transmitted to the SRF in part with invoking the SRF. Instructions are provided in connection with invoking the SRF instructing the SRF to return the correlation ID in a message back to the multi-SLEE. That is, program embodiments execute to instruct the SRF that once the SRF begins a SRF dialog it is to return the correlation ID in a message to the multi-SLEE.

As part of a SRF dialog messages are exchanged with a dispatcher in a SLEE environment providing a service control function (SCF) in association with a service control point (SCP) in the above described networks. In a multi-SLEE environment, however, the dispatcher receiving this return message may or may not be contained in the SLEE having the invoking SLP. Embodiments of the present invention allow the dispatcher to check if it does.

According to the various embodiments, program instructions execute using the SLEE dispatcher which received the return SRF message, e.g., the return message having the correlation ID, to look up the SLEE instance of each invoking SLP in memory associated with that SLEE in reference to the correlation ID in the message. Program embodiments execute instructions such that if a correlation ID received in a return SRF dialog message from an invoked SRF matches with a correlation ID of a SLEE instance found by the dispatcher then the SRF dialog can be forwarded to the invoking SLP instance, as illustrated generally at 530. If the correlation ID does not match with a correlation ID in memory associated with the SLEE, then the SLEE can create a new SLP instance to handle the SRF dialog. One of ordinary skill in the art will appreciate the manner in which program instructions can execute to forward the SRF dialog to the invoking SLP instance when a match is found. Further detail relating to the same is not provided here so as not to obscure embodiments of the invention.

Thus, in a multi-SLEE environment, rather than having to create a new SLP instance each time a new SRF dialog is received, when a SLEE instance match is found, a SLP instance can be conserved. By virtue of the various embodiments described herein, the number of SLP instances employed to handle a session, e.g., message exchange/dialog, can be reduced. If the SRF dialog is controlled by the same SLEE that contains the invoking SLP instance, the dialog is forwarded to the existing SLP instance rather than creating a new SLP instance. The reader will appreciate that a conservation of SLP instances conserves memory and thus allows more instances to handle more sessions on identical hardware.

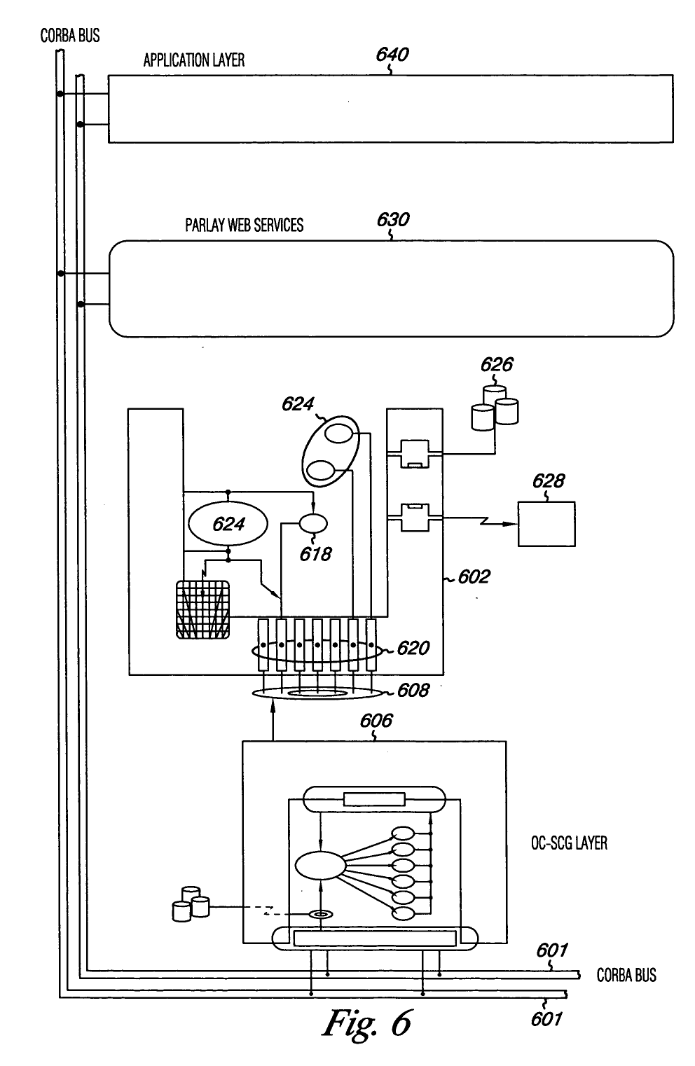

FIG. 6 illustrates an embodiment of a network which can include a multi-SLEE environment 602 (such as discussed and illustrated in connection with FIGS. 4 and 5), including a plug-in container 606 (e.g., which one of ordinary skill in the art will appreciate can serve as part of a service control gateway), and having an interface, e.g., via a high speed bus 601, to web service applications, such as Parlay applications which invoke Parlay web services 630, and/or to other application layers 640.

Parlay web services 630 are intended to refer to a set of web-services that can be described using web services definition language (WSDL) by application and service creation designers. The Parlay web services 630 can include Parlay APIs (not shown) which are designed to enable creation of telephony applications as well as to enable information technology applications.

Parlay web services accommodate the development of next generation network applications. The interaction between an application incorporating a Parlay web service and a server implementing the web service, e.g., a service capability server (SCS) or service control gateway (SCG) implementing the multi-SLEE embodiments described herein, can be performed using an extensible markup language (XML) based message exchange through the high speed bus 601. Parlay web services are not network equipment specific, and are not network specific where a particular capability is relevant to more than one type of network.

One of ordinary skill in the art will appreciate upon reading this disclosure that Parlay applications to invoke Parlay web services 630, and/or other service application layers 640, can interact with an SS7 network including the use of a service control function (SCF) in a service control point (SCP), having a multi-SLEE environment according to the embodiments described above.

Although specific embodiments have been illustrated and described herein, those of ordinary skill in the art will appreciate that an arrangement calculated to achieve the same techniques can be substituted for the specific embodiments shown. This disclosure is intended to cover adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A service control point (SCP) in a communication network, comprising:
program instructions associated with a service control function (SCF) executable within a multiple service logic execution environment (multi-SLEE), each SLEE in the multi-SLEE having a dispatcher and access to a processor and a memory; and
wherein the program instructions are storable in the memory and executable by the processor, for each SLEE in the multi-SLEE, to:
save SLEE instance information to memory in association with creating a service logic program (SLP) instance to invoke a specialized resource function (SRF) within the network; and
use the dispatcher to look up SLEE instance information based on a message received from the SRF.

2. The SCP of claim 1, wherein as part of saving the SLEE instance information, the program instructions can execute to generate a correlation identifier (ID) representative of a particular SLEE and a particular SLP instance that invoked the SRF.

3. The SCP of claim 2, wherein the correlation ID is keyed to memory as a variable length bit string.

4. The SCP of claim 2, wherein the program instructions can execute to transmit the generated correlation ID to the SRF as part of the SLP instance invoking the SRF.

5. The SCP of claim 4, wherein the SRF can execute instructions to start a SRF dialog and to return the correlation ID to the multi-SLEE.

6. The SCP of claim 5, wherein the program instructions execute to forward the SRF dialog to the invoking SLP instance when the correlation ID matches SLEE instance information located by the dispatcher in a SLEE receiving the message.

7. The SCP of claim 5, wherein the program instructions execute to create a new SLP instance to handle the SRF dialog when the correlation ID does not match SLEE instance information located by the dispatcher in a SLEE receiving the message.

8. A method for managing service logic program (SLP) instances in a multiple service logic execution environment (multi-SLEE), comprising:
for each SLEE in the multi-SLEE, saving SLEE instance information to a memory in association with creating a service logic program (SLP) instance to invoke a specialized resource function (SRF) in a communications network;
upon a SLEE receiving a correlation ID message from a SRF dialog, performing a look up of SLEE instance information using a dispatcher on the SLEE.

9. The method of claim 8, wherein the method includes generating the correlation ID representative of a particular SLEE and a particular SLP instance invoking a particular SRF as part of saving SLEE instance information.

10. The method of claim 9, further including transmitting the correlation ID to the SRF as part of the SLP instance invoking the SRF.

11. The method of claim 10, wherein generating and transmitting the correlation ID includes:
keying the correlation ID to memory as a variable length bit string implemented in one or more octets; and
transmitting the one or more octets to the SRF.

12. The method of claim 11, further including returning the correlation ID to the multi-SLEE as part of a SRF dialog being invoked by an SLP instance within the multi-SLEE.

13. The method of claim 8, further including forwarding the SRF dialog to an invoking SLP instance when the correlation ID matches SLEE instance information located by the dispatcher in the receiving SLEE.

14. A computer readable medium having a program to cause a device to perform a method, comprising:
generating a correlation ID representative of a particular service logic execution environment (SLEE) within a multiple-SLEE environment and representative of a particular service logic program (SLP) instance within the particular SLEE created to invoke a specialized resource function (SRF); and
keying the correlation ID to a memory associated with the particular SLEE.

15. The medium of claim 14, further including keying the correlation ID to the memory as a variable length bit string.

16. The medium of claim 14, further including transmitting the correlation ID to the SRF.

17. The medium of claim 16, further including returning the correlation ID to the multi-SLEE.

18. The medium of claim 17, further including receiving the correlation ID at a SLEE within the multi-SLEE and looking up the correlation ID in memory associated with the SLEE.

19. The medium of claim 18, further including forwarding a SRF dialog to the particular SLP instance which invoked the SRF when the correlation ID matches a correlation ID located by the dispatcher.

20. The medium of claim 18, further including creating a new SLP instance to handle a SRF dialog when the correlation ID does not match a correlation ID in memory associated with the SLEE.

21. A communication network, comprising:
a service switching point (SSP);
a signal transfer point (STP) coupled to the SSP; and
a service control point (SCP) coupled to the STP, wherein the SCP includes:
program instructions associated with a service control function (SCF) executable within a multiple service logic execution environment (multi-SLEE), wherein the program instructions, for each SLEE in the multi-SLEE, are executable to save SLEE instance information to memory.

22. The network of claim 21, wherein the program instruction execute to save SLEE instance information to memory in association with creating a service logic program (SLP) instance to invoke a specialized resource function (SRF) accessible by the network.

23. The network of claim 21, wherein each SLEE in the multi-SLEE includes a dispatcher, and wherein the program instructions are executable to use the dispatcher to look up SLEE instance information based on a message received from a SRF.

24. The network of claim 21, wherein the program instructions are executable to:
generate a correlation ID representative of a particular SLEE within a multiple-SLEE environment and representative of a particular SLP instance within the particular SLEE created to invoke a specialized resource function (SRF); and
key the correlation ID to a memory associated with the particular SLEE.

25. The network of claim 24, wherein the program instructions are executable to transmit the correlation ID to the SRF.

26. The network of claim 25, wherein the SRF includes instructions executable to return the correlation ID to the multi-SLEE.

27. The network of claim 26, wherein the program instructions are executable to forward a SRF dialog to a particular SLP instance which invoked the SRF when the correlation ID matches a correlation ID keyed to memory associated with a SLEE receiving the correlation ID.

28. The network of claim 21, wherein the SRF includes executable instructions to start a dialog for access to a web service application.

29. The network of claim 21, wherein the SRF includes executable instructions to start a dialog for access to a Parlay application.

30. A communications network, comprising:
a service control point including a service control function executable as part of a multiple service logic execution environment (multi-SLEE), each SLEE in the multi-SLEE having access to a processor and a memory; and
means for forwarding a SRF dialog to an invoking SLP instance when the SRF dialog is received by a SLEE, within the multi-SLEE, which includes the invoking SLP.
